(19) United States
(12) Patent Application Publication
(10) Pub. No.: US 2005/0091411 A1
(43) Pub. Date: Apr. 28, 2005

(54) Integrated system for providing user services

(76) Inventors: Sameh Michaiel, San Jose, CA (US); Taram Devitt-Carolan, Campbell, CA (US); Ayman W. Habib, San Jose, CA (US); Moenes Zeher Iskarous, San Jose, CA (US); Anthony Magliulo, Fremont, CA (US)

Correspondence Address: Sameh Michaiel, 4229 Littleworth Way, San Jose, CA, 95135, US

(21) Appl. No.: 10/972,047

(22) Filed: Oct. 22, 2004

Related U.S. Application Data
(60) Provisional application No. 60/514,441, filed on Oct. 24, 2003.

(51) Int. Cl. G06F 15/16; G06F 15/173

(52) U.S. Cl. 709/249; 709/250; 709/238; 709/245

(57) ABSTRACT

A system with an integrated user interface that provides a unified view of heterogeneous services via heterogeneous network nodes connected to heterogeneous networks. Access to services is provided without the need for installation of service-specific software on network nodes. Services that can be provided at multiple locations are performed at a location selected by the system based on the user's location. The system can update user preferences dynamically based on the user's history of service requests via the integrated user interface. The system can merge the preferences of multiple users for cases when multiple users all are impacted by the same preference.

### CROSS-REFERENCE TO RELATED APPLICATIONS

This application claims the benefit of PPA Ser. No. 60/514,441, which is filed 24 Oct. 2003, th& disclosure of which is hereby incorporated herein by reference in its entirety.

### FIELD OF THE INVENTION

The present invention relates generally to providing services to users of a private network.

### BACKGROUND OF THE INVENTION

Businesses use communication networks for tasks such as generating revenue, reducing costs, or efficient management. A general definition of a communication network is a system that allows the sharing and distribution of information among multiple people and computers. Many businesses have one or more private networks. A private network is a network such that usage of the network and its associated resources are controlled or restricted to a defined group of users, such as the employees of a company. Examples of private networks include local area networks (LANs), cable television (CATV) networks and private branch exchanges (PBXs).

Newer buildings also may contain a building control network that allows control of the building physical plant from a central controller. Control inputs include thermostats, electrical switches, and motion sensors. Controlled elements include furnaces, air conditioners, and electrical power.

Private networks often are connected to compatible public networks. Examples of public networks include frame relay networks, satellite television networks, and the public switched telephone network. Often an interface unit is used at the boundary between the private and public networks, and the interface unit places restrictions on how information flows across the boundary. Examples of an interface device include firewalls and call routers for long distance telephone service.

Each network has user nodes that connect to the network and provide a means for users to interact with services via a network. Examples of user nodes on a LAN include computers, personal digital assistants, printers and scanners. Examples of user nodes on a CATV system include televisions, set-top boxes and video servers. Examples of user nodes on a PBX include telephones and modems. Examples of user nodes on a building control network include thermostats.

Each network also has service nodes that connect to the network and provide access to services of interest to a user. Examples of service nodes on a LAN include printers, print servers, scanners, and storage servers. An example of a service node on a CATV network is a video server. An example of a service node on a PBX is a voicemail server. Examples of service nodes on a building control network include furnaces, air conditioners, and electrical power controllers.

Often a single user will access services on one or more networks using different nodes. For example, a single user may use a computer, telephone and personal digital assistant. The specific node used at any given time depends on the desired service and perhaps other things as well, such as the user's location within a building. FIG. 1 shows a services infrastructure with multiple private and public networks, user nodes, server nodes and interface units. The private networks include a CATV network 100, a LAN 200, a PBX 300, and a building control network 400. The public networks include a satellite television network 510, a frame relay network 520 and a public switched telephone network 530. A firewall 250 controls the data flow between the private LAN 200 and the public frame relay network 520. The user nodes are a television 110, a set-top box 120 with its associated remote control unit 130, a personal computer 210, a personal digital assistant (PDA) 220, a telephone 310, a modem 330, a motion detector 420, and a thermostat 430. The service nodes are a video server 140, a printer 230, a print server 240, a voicemail server 320, a power switch 410, and an air conditioner 440. The environmental control system 450 also acts as a service node because users can request changes to the environment, such as desired room temperature.

Each different service is limited to a specific type of network node as a user interface. For instance, a voicemail service is accessed via a telephone and a video service is accessed via a set-top box. In addition, the user interfaces of different services are not uniform, and thus, a burden in placed on the user to learn to operate services with a variety of user interfaces. FIG. 2 shows how different services are accessed in a prior art services infrastructure. User node 610 interfaces to application 750 and application 760 that are contained on server 710, and application 770 that is contained on server 720. User interface 620 interfaces to application 780 on server 730. We assume that user node 610 is incompatible with application 780, and that user node 620 is incompatible with applications 750, 760 and 770.

Ideally, all available services would be available via a single integrated user interface. The integrated user interface can be accessed from different types of network nodes and the manner in which the virtual interface is presented to and controlled by the user is customized for each different type of network node. Also, the virtual interface could provide more uniform user interfaces across most or all of the desired services.

The way in which a network and services infrastructure is used in a business may change, depending on the characteristics of the user population. In particular, a highly transient user population may have preferences that differ from those of other types of businesses. The specific example upon which we will concentrate is that of a hotel. The majority of users of the hotel's communication networks and associated services are hotel guests, and thus, a hotel has a highly transient user population.

One potential issue for highly-transient users is the ability to access available services without the need for installing service-specific software, such as a device driver for a printer.

Another potential issue for highly-transient users is locating and using physical devices, such as printers, that are attached to a network. For example, it may be useful to print a document at the printer that is closest to the user.

Another potential issue for highly-transient users is the ability to customize preferences automatically. Many services allow preferences to be set, but it is inconvenient to set the preferences each time the user moves. Particularly in the case of a hotel, when a guess returns to the hotel, it is desirable that the guest's preferences be set as they were during the last visit.

A user may store his initial preferences somewhere in the services infrastructure. Over time, it may be that a user's preferences will shift. For example, a hotel guest that initially preferred a hotel room that allows for smoking may quit smoking and in future desire a hotel room that does not allow smoking. Ideally a services infrastructure would contain a mechanism for updating user preferences by observing changes in user behavior.

In addition to user preferences, manager preferences are important as well. For example, a user may have a preference for a desirable room temperature, but the business may have a preference to place a limit on the minimum or maximum temperature of a room. Services provided to a user that are customized based on preferences should be customized based on a combination of user and business preferences. A similar mechanism could combine the preferences of one or more users if each user's preference impacts the other users, e.g., the case of controlling the temperature in a room shared by multiple users.

Although the previous discussion focuses on a system in a hotel, many of the features of the system also would be desirable in other situations, such as within a home or corporate environment.

### SUMMARY OF THE PRESENT INVENTION

An object of the invention is to provide an integrated services platform that combines multiple networks, multiple nodes and multiple services. Another object of the invention is to provide a user interface provides a uniform interface across heterogeneous services. Another object of the invention is to provide services without requiring the addition of software to network nodes. Another object of the invention is to provide the ability to execute services in a way that takes advantage of knowledge of the user's location. Another object of the invention is to enable the integrated services platform to provide environmental monitoring and control. Another object of the invention is to provide a means to store and dynamically update user preferences based on user inputs and user behavior. Another object of the invention is to provide a means combined the preferences of multiple users for services that impact multiple users.

### BRIEF DESCRIPTION OF THE FIGURES

These and other features and advantages of the invention will be more readily understood from the following detailed description of the invention which is provided in connection with the accompanying drawings, in which:

FIG. 1 shows a services infrastructure with communication networks, user nodes, server nodes and interface units.

FIG. 2 shows the prior art architecture for accessing services in a services infrastructure.

FIG. 3 shows an improved architecture for accessing services in a services infrastructure.

FIG. 4 shows an example user interface display.

FIG. 5 shows an example user interface display.

FIG. 6 shows an extended version of the architecture of FIG. 3 that supports heterogeneous user node types.

FIG. 7 shows a means of translating between incompatible information formats on different network types.

FIG. 8 shows the architecture of a print service that requires no printer server software on the user node.

FIG. 9 shows an environment monitoring device.

FIG. 10 shows an environment modification device.

FIG. 11 shows a circuit breaker replacement device.

FIG. 12 shows a database that holds user preferences.

FIG. 13 shows an architecture of a system that automatically updates user preferences.

FIG. 14 shows an architecture of a system that recommends updates to user preferences.

FIG. 15 shows a database that holds combined user/management preferences.

FIG. 16 shows a database that holds both user and management preferences and a means to combine the preferences.

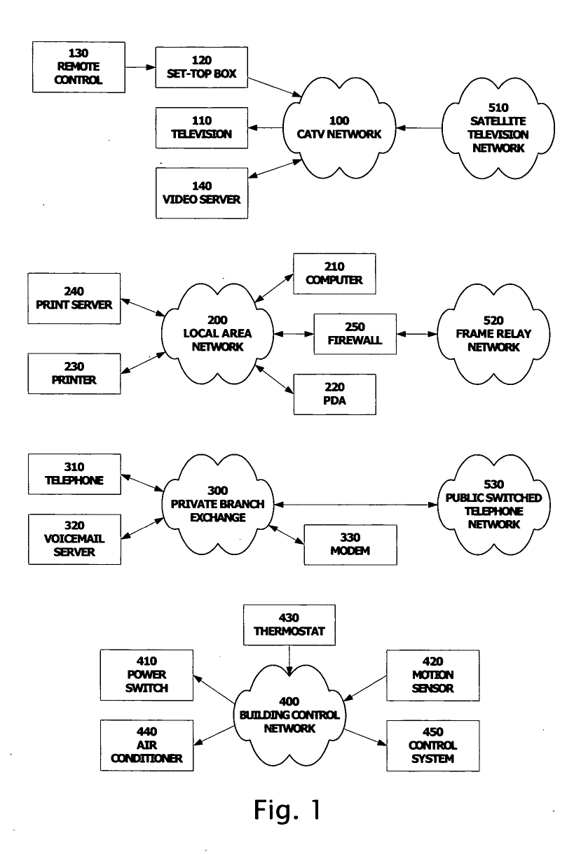

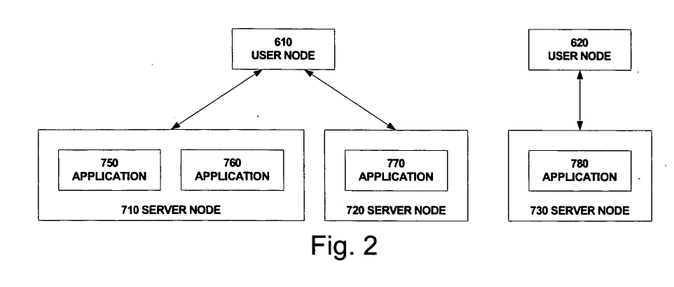

### DETAILED DESCRIPTION—INTEGRATED USER INTERFACE TO SERVICES

In the following detailed description, reference is made to the accompanying drawings, which form a part hereof, and in which is shown by way of illustration specific embodiments in which the invention may be practiced. These embodiments are described in sufficient detail to enable those of ordinary skill in the art to make and use the invention, and it is to be understood that structural, logical, or procedural changes may be made to the specific embodiments disclosed without departing from the sprit and scope of the present invention. References to “an” or “one” embodiment in this disclosure are not necessarily to the same embodiment, and such references mean at least one.

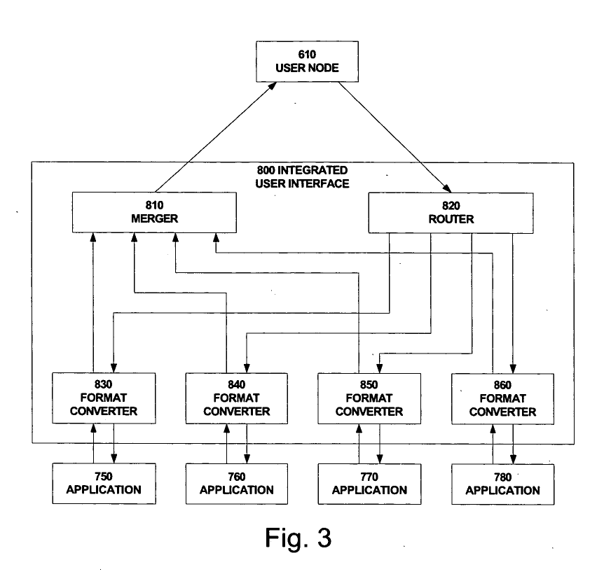

Users of services in a services infrastructure desire a uniform way to access services. An aspect of the invention is the ability to provide an integrated view of services available on heterogeneous networks, and to present that view on a heterogeneous set of network nodes. FIG. 3 shows the elements of an architecture to provide an integrated user interface to heterogeneous services. In FIG. 3, the user node 610 directly accesses an integrated user interface 800. In turn, integrated user interface 800 connects to applications 750, 760, 770 and 780. Within integrated user interface 800, merger 810 combines the inputs from applications 750, 760, 770 and 780 into a single uniform interface. For example, merger 810 could combine the information from the four applications and display the results on a single HTML page on a web server.

Integrated user interface 800 also contains a router 820 that accepts user inputs via user node 610 and sends each user input to the appropriate application. Router unit 720 examines each user input to determine to which application to which the user input should be sent. For example, a request to view a movie would be sent to a video server and a request to listen to voicemail would be sent to a voicemail server. Routing could be based on things such as the location of a command select button on an HTML page or on some element contained within the command itself.

Because different applications may have different interfaces, some type of format conversion may be required to produce integrated user interface 800. Consequently, integrated user interface 800 contains a format converter for each different application interface (API). Thus, format converter units 830, 840, 850 and 860 provide format conversion for applications 750, 760, 770 and 780, respectively. The format converters provide a uniform look-and-feel to the user for the various applications.

An example of format conversion for the path from application to user node 610 is taking the program listing data usually displayed on a television by a set-top box and reformatting the information to allow display on an HTML page. An example of format conversion for the path from the user node 610 to an application is taking user commands from user node 610 for voicemail access and converting them into touch-tone commands that can be understood by a voicemail server. The format converters may do more than just simple one-to-one conversion of individual information blocks or user commands. A format converter also may include internal state to simplify the command interface. By tracking the commands that have been executed by the user recently, a simpler set of commands can be offered to the user. For example, if all recent commands have been executed on a specific printer, the format converter could insert the name of the specific printer automatically for commands sent to the printer without requiring that the name of the specific printer be specified in each user command.

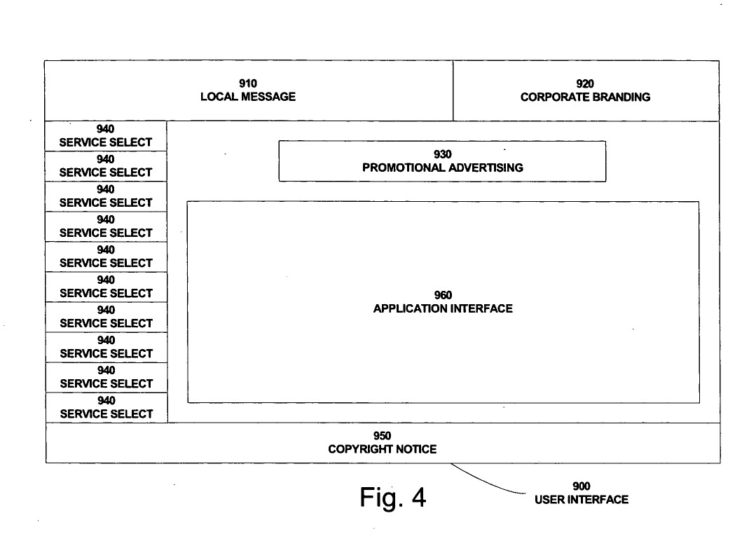

FIG. 4 shows an example user interface. The user interface is an HTML page as would be displayed by a network browser program run on a computer, and we call this the user interface 900. The application interfaces 960 may be reformatted from their original appearance to provide a more integrated and consistent interface. In addition to the application interface 960, the user interface 900 also provides a frame that contains other information. The local message 910, corporate branding 920, promotional advertising 930, and copyright notice 950 from a frame around the application interface 960. Also, a set of service select controls 940 allows the user to select other services that are provided by other applications. The other services may be accessible via both the private and public networks.

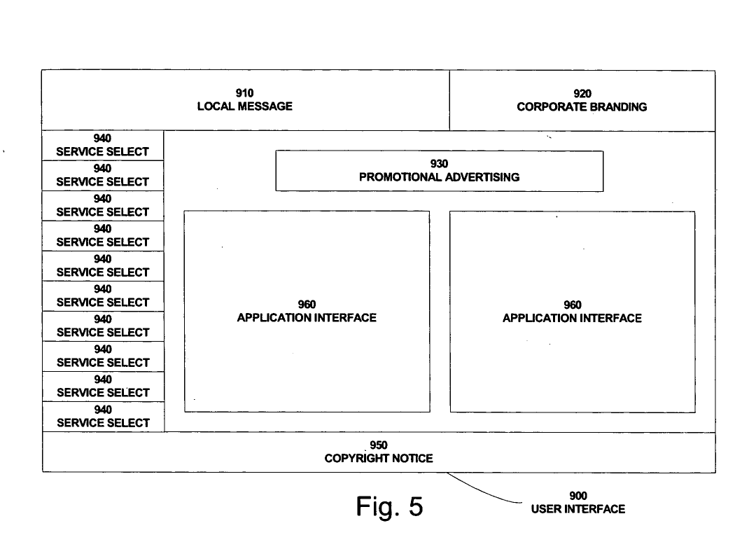

FIG. 5 is identical to FIG. 4 with the exception that user interface 900 contains two application interfaces 960 to illustrate that more than one application may be active simultaneously.

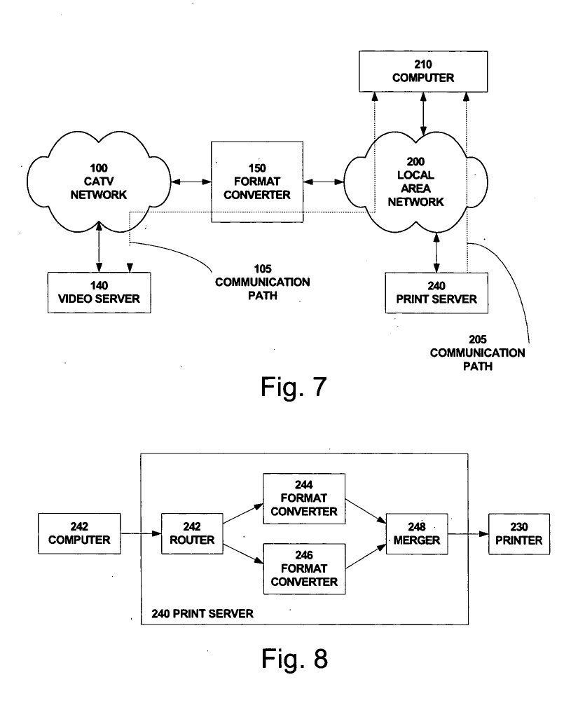

As previously described, FIG. 3 provides a conceptual view of how to provide uniform access to services. However, if different services are on different types of networks, then a format conversion unit may be required to translate the information from a format compatible with the first type of network to a format compatible with the second type of network. FIG. 7 shows two different types of networks that interface to a format conversion unit. The CATV network 100 and LAN 200 are connected via format converter 150. Computer 210 can access printer server 240 directly using communication path 205 through LAN 200. Computer 210 also can access video server 140 using communication path 105 through LAN 200, format converter 150 and CATV network 100. Although the format conversion unit is shown as an independent unit, the same functionality could be incorporated into another unit, such as a server computer. For example, a video signal on a CATV network 100 from video server 140 can be converted by format converter 150 into a packetized digital data stream suitable for LAN 200.

Although the previous description discusses a system for service users, similar techniques can be used for service providers as well. For example, consider room service that is ordered via a telephone and via computer. The room service manager would like a single integrated view of all of the orders placed with room service.

Different types of users may have different capabilities. For example, a user who is an employee may not have the same access to services as his or her manager. An authentication system can be used to verify the identity of a user to assure that only authorized users have access to various services.

If multiple services on a given network all need similar types of format conversion for the user interface, some of the functionality of a format converter in the user interface, e.g., format converter 830, can be moved into format converter 150 that is between two networks.

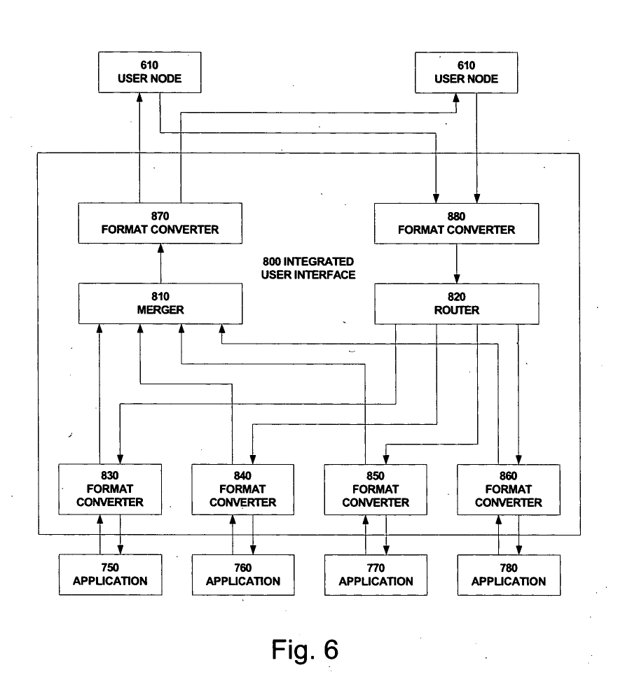

In FIG. 3, the integrated user interface 800 supports only a single type of user mode. However, it may be that we cannot assure that all users have access to the same type of user node. Also, it may be convenient for users to have access to the same integrated user interface 800 via different types of user node at different times or in different locations. FIG. 6 shows an extended version of the architecture shown in FIG. 3. In addition to the elements contained in FIG. 3, FIG. 6 includes an additional user node 620 as well as format converters 870 and 880 for user nodes 610 and 620, respectively. The purpose of format converts 870 and 880 are to adapt integrated user interface 800 to the specific characteristics of user nodes 610 and 620. For example, if user node 610 is a personal computer, the then the integrated user interface 800 could be presented with an HTML page. Alternatively, if user node 620 is a telephone, then the integrated user interface 800 could be presented as a series of audio outputs.

System information need not reach the user only through the user interface. For example, assume that the user wishes to view a movie on the television his or her room. The request for the movie could be made via the user interface; however, the video server then could send the video directly to the television without the video signal passing through the user interface.

### DETAILED Description—Service Access without Additional Software

Users desire the ability to access services without being required to install additional software. This can be achieved by running the applications that provide the desired services on a server computer rather than on the computer that is the user node. Access to the application is provided via an application that already exists on most computers, such as a web browser.

A specific example of a service that requires the installation of additional software is printing. In a conventional system, the user is required to install software in the form of a printer driver on the user's computer, the printer driver software allows the computer to send data to the printer in a printer-specific format.

One aspect of the invention is a means for printing that does not require the installation of a printer driver on the user's computer. Instead, a server is provided that translates a file from the user's computer into a format that is compatible with the desired printer. For example, the user can submit a file for printing in Microsoft Word format. The server will invoke the Microsoft Word application to convert the user's file into a format that is compatible with the desired printer.

The general architecture of such a service consists of an application routing module and multiple application programs that can covert files in common formats into formats that are compatible with one or more printers. The application routing module examines the file to be printed, determines the most appropriate application for performing the format conversion, and invokes that application. Selection of the appropriate application for format conversion can be done by observing the file name suffix. For example, a file in Microsoft Word format usually uses a “doc” file name suffix. Another possibility is to look at some part of the file contents to determine the appropriate format converter. For example, a Unix file contains a “magic number” that denotes the application that generated the file.

FIG. 8 shows the infrastructure required to provide a printing service that does not require the installation of printer driver software on the user node. Computer 210 sends a file to be printed to print server 240. Within print server 240, router 242 examines the file to be printed and selects either format converter 244 or format converter 246 to convert the file into a printable format. Once the file has been changed into a printable format, the file passes through merger 248 and is passed to printer 230. Printer 230 may be connected directly to printer server 240 or accessed via a network.

The user interface for this print service is provided by the server via a web page in HTML format. The web browser application on the user node is used to control the application that formats the file for the printer. The file to be printed is uploaded to the server for format conversion. Another aspect of the printer service interface may include the ability to select a printer in some manner, such as printer capability, printer type and printer location.

### Detailed Description—Service Location Selection Based on User Location

Another aspect of the invention is the ability to perform services at a desired location without requiring the user to identify the resource specifically. For example, it may be desirable to print something on the printer that is nearest the user, without the user being required to go through a list of printer names and choose one based on its location. We use the word “name” to refer to any combination of names to identify a specific printer. For example, identifying a printer may require knowledge of both the printer name and the name of the domain or network of which the printer is a part.

A way to select the printer that is close to the user is to determine the user's location based on the location at which the node used by the user interfaces to the network. For example, a network can be divided into a group of smaller networks that are interconnected by units such as switches and routers. The location of the specific network to which the user is connected provides an approximate idea of the location of the user. Once the user's location is known, then the nearest printer can be selected from a list of printers. The user is then notified of the location at which he/she can retrieve the printout. The system provides options to the user to select and direct printing of the document to specific printer from a list of available printers including a default printer.

### Detailed Description—Remote Control of Service Execution

Another aspect of the invention is a mechanism for controlling the time at which a service is performed. For example, a user may send a sensitive document to a printer and not want the document to print until he is standing by the printer to assure that no one else sees the document. One way to do this would be for the user to specify a time at which the document will print.

Another way to do this is to provide a user node next to the printer that allows a user to request that a pending print job be printed. The user could access his existing integrated user interface via the printer's user node to request that a pending job be printed.

Alternatively, all pending print jobs can be stored in a shared print queue. For secure printing, the system can generate a pass code. The pass code is sent to the user via email, a web page or another form external to the system such as pager, fax or voice mail. Alternatively, the pass code could be generated by the printer; or printer administrator; or chosen by the user, the code is then entered by the user in a key pad of a printer, which authorizes the user and allows the printer to start printing. To increase security, the pass codes could expire after a set amount of time, such as 20 minutes.

### Detailed Description—Environmental Monitoring and Control

Environment control is a valuable service for users, particularly for highly-transient users such as guests in a hotel. Although some buildings may have remote monitoring and control of environmental systems, many buildings do not. It would be advantageous to be able to retrofit an existing building with environmental controls in a cost-effective way.

An environmental control system requires several components, including devices for monitoring the environment, e.g., a thermostat, devices for modifying the environment, e.g., an air conditioner, a control system that accepts inputs from the environment monitoring devices and provides outputs to environment modifying devices, and a communication system to link all of the components together.

For an existing building, installing a new communication system with wires for environmental control would be prohibitively expensive. A more cost-effective method is to use an already-existing communication system, a wireless communication system, or a combination of both. If a building already contains a LAN, the LAN is an ideal communication infrastructure for an environmental control system. The environmental control system can connect directly to a wired LAN where convenient, or depend on wireless access to the LAN via an access point running a wireless communication protocol, such as 802.11. Other LAN devices are available that use existing power lines or telephone lines to carry information rather than using wires installed specifically for the LAN.

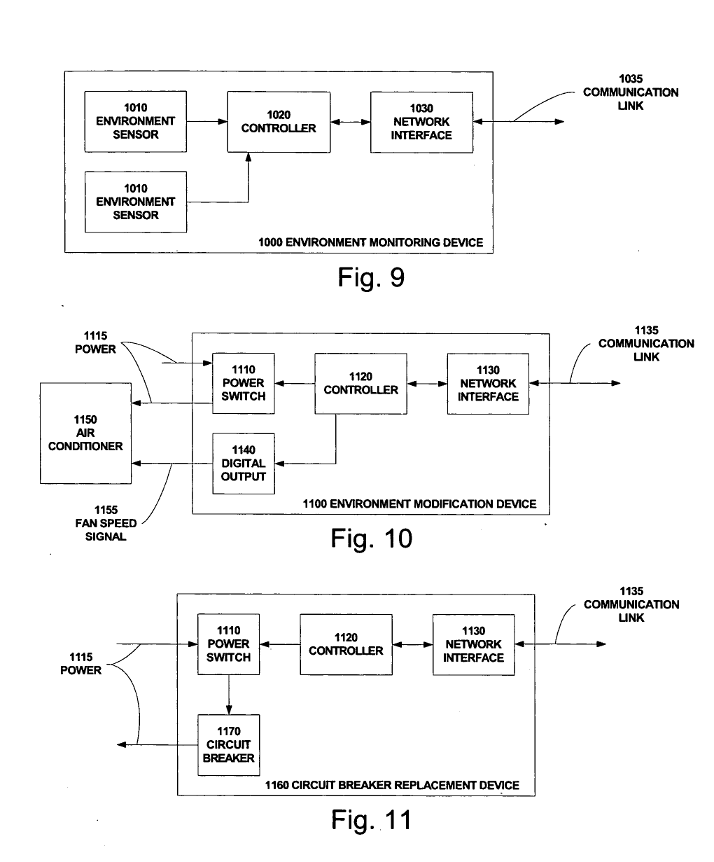

For environmental monitoring, devices are required that sense one or more aspects of the environment and communicate the sensor information to the environmental control system. FIG. 9 shows an environment monitoring device 1000. The device consists of one or more environment sensors 1010. Examples of environment sensors include thermostats, humidistats, motion sensors, heat sensors, smoke sensors and sound sensors. A controller 1020 takes the outputs of environment sensors 1010 and arranges the data into a format compatible with network interface 1030. Controller 1020 may perform other functions as well, such as accumulation and averaging of sensor information, determining whether environmental conditions are within acceptable limits and sending alarm signals if they are not, and so forth. Network interface 1030 connects to the communication network via communication link 1035.

An environmental control system receives environment information from the environment monitoring devices and sends commands to the environment modifying devices. One aspect of the invention is to link the environmental control system to the integrated user interface. The user can interact with the environmental control system by requesting information, such as the status of various environmental conditions, e.g. the current temperature of the room that is occupied by the user. The user also may be permitted to alter some or all aspects of the environment, such as requesting the desired room temperature. The user may alter environmental settings directly, or may specify a set of preferences to the control system that are dependent on events or time. For example, the user may request that the room temperature be 70 F degrees during the day, but reduced to 65 F degrees after 11 PM.

Environment modifying devices somehow must be controllable. FIG. 10 shows an example of an environment modification device 1100 used to control an air conditioner 1150. Commands from the environmental control system are received by device 1100 by network interface 1130 via communication link 1135. The controller 1120 takes the received information and determines the necessary outputs to generate to control air conditioner 1150. The air conditioner 1150 is controlled in two ways. Power 1115 to the air conditioner is provided via power switch 1110 and controller 1120 determines the state of power switch 1110. The fan speed of air conditioner 1150 is controlled by fan speed signal 1155 that is generated by digital output 1140. Controller 1120 controls fan speed via digital output 1140 because the control circuitry may not be able to handle the voltage or current required for fan speed signal 1155.

A cost-effective way of retrofitting an existing building to allow control of electrical power is to replace the existing fuses or circuit breakers in a building with new devices that combine a circuit breaker and a remotely operable power switch. FIG. 11 shows a device intended to replace an existing circuit breaker or fuse. The circuit breaker replacement device 1160 receives commands from the environmental control system by network interface 1130 via communication link 1135. The controller 0.1120 takes the received information and determines the state of power switch 1110, and power switch 1110 controls power 1115. Device 1160 also contains a circuit breaker 1170 to assure that device 1160 interrupts the circuit if current draw becomes excessive.

Because circuit breaker replacement device 1160 already is connected to a power line, the most convenient communication link 1135 may be the power line itself. LAN devices that send data over power lines already are commercially available. Alternatively, wireless LAN access could be used, if desired.

### Detailed Description—Dynamic Update of Preferences

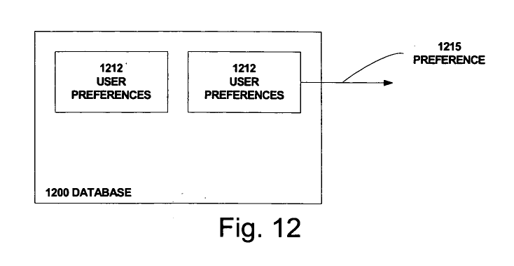

One of the services available in the services infrastructure is the ability to customize user preferences. User preferences are stored in a database. FIG. 12 shows a user preference record 1210 stored in database 1200. The user preference is provided to the rest of the system via preference output 1215. User preferences can be put into the database explicitly by the user, or loaded into the database from another database that already exists.

User preferences not only include service preferences but also may include environmental preferences. For example, rather than setting the desired temperature of a room by changing the thermostat, the desired temperature could be stored in a database of user preferences. User preferences include the ability to specify preferences for a variety of situations. For example, the desired temperate may differ depending on the time of day, or whether motion is detected in the room.

The value of storing user preferences is not only comfort and convenience for the user, but also cost savings by reducing energy consumption. Although the ability to store environmental preferences is a convenience for any user, such stored preferences are most valuable to highly transient users, because highly transient users are the ones that move from one place to another most often.

User preferences for services often are activated when a user logs into an account, or otherwise authenticates himself/herself to an application. Environmental preferences are of a different nature, however. It is desirable that environmental preferences be activated as soon as a user starts occupying a room and deactivated when the user stops occupying a room. For example, this could be done at the time that a user checks into or out of a hotel.

Another aspect of the invention is the ability to dynamically update preferences. One of the values of having a single integrated view of services is that it may be possible to infer user preferences based on services requested by the user. For example, a user whose stated preference is for Coca Cola may switch to Pepsi Cola. Observing the user's interaction with various services in the system can be a means to determine whether a user's actions match the known set of user preferences. In this case, monitoring user requests to room service might show a change in preference for soft drinks.

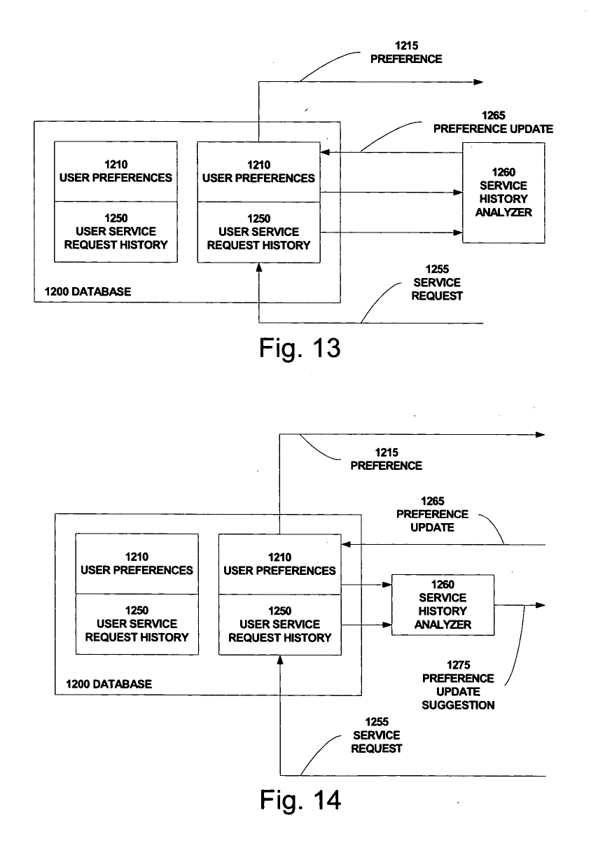

FIG. 13 shows an architecture that provides automatic updates of user preferences. Database 1200 contains a pair of database records for each user, a user preference record 1210 and a user service request history record 1250. User preferences are provided to the rest of the system via output 1215. Service requests are received from the rest of the system via input 1255. A service history analyzer 1260 looks for patterns in the service request history to estimate a user preference and compares the estimated user preference with the actual user preference. If the two user preferences are not the same, then the estimated user preference is used to provide user preference update 1265.

In some cases, users may object to a mechanism that updates user preferences without the user's explicit permission first. FIG. 14 shows a modified version of the preference update system of FIG. 13. The difference is that rather than performing a user preference update automatically, the service history analyzer 1260 provides a preference update suggestion 1275 to the user. The user then generates a user preference update 1265, if desired.

### Detailed Description—Combined Preferences

Although user preferences are important, management preferences are important as well. Typically management preferences implement some desired management policy. For example, management may wish to block access to specific web sites that are unlikely to be work related. In other cases, the management preferences may be default preferences that are used in the absence of specific user preferences. For example, a management preference may specify the default temperate in an unoccupied room.

The overall behavior of the services infrastructure should depend on a combination of user preferences and management preferences. User and management preferences may be stored in separate database records or in merged database records.

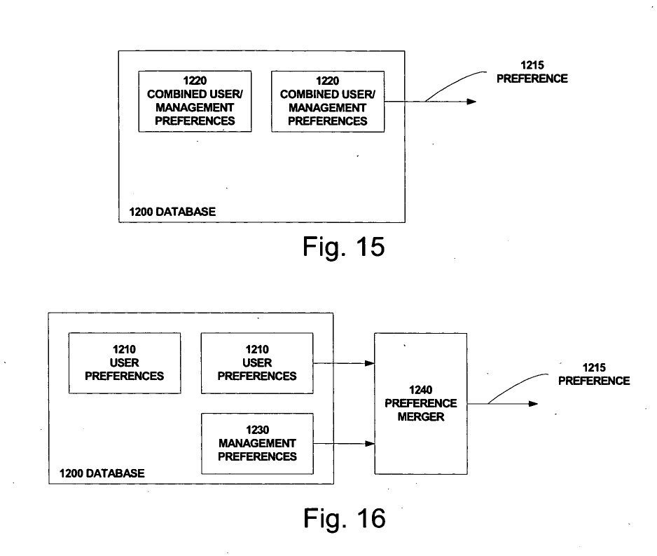

FIG. 15 show a database 1200 that contains database records 1220 that holds a combination of user and management preferences. The combined preference is provided to the rest of the system via preference output 1215. FIG. 16 shows a database 1200 holds a management preference record 1230 and a number of user preference records 1210. FIG. 16 also shows a preference merger 1240 that takes a management preference 1230 and a user preference 1210 and produces a combined preference for the specific user. The combined preference is provided to the rest of the system via preference output 1215.

Whether the database architecture of FIG. 15 or FIG. 16 is used, user and management preferences can be combined in numerous ways. One example is that management preferences could be the default preferences and the user preferences will override the management preferences. Another example is that management preferences may place limits on user preferences, such as the minimum or maximum temperature that can be selected for a room.

We have described a system with two classes of preferences, and the basic idea could be extended to cover any number of classes. For example, the classes in the system could be hierarchical to reflect the hierarchical nature of a corporation. Thus, a first class is for the company president, the second class is for employees at the vice presidential level, and so forth.

Although we have discussed combining user and management preferences, it is possible to combine any set of preferences if desired. For example, if two users share a single room, then the preferences used to control the room environment should be a preference that reflects the combined preferences of both users.

1. A system for providing an integrated user interface for access to services, comprising:
a plurality of user nodes;
a plurality of servers;
a plurality of applications that provide a plurality of services running on said servers;
a merger for combining the user interface outputs from a plurality of applications; and
a router for selecting a destination application from among a plurality of application to receive a user node input.

2. The system of claim 1, wherein said system further contains a plurality of format converters.

3. The system of claim 1, wherein said user node has a type selected from the group consisting of:
computer;
personal computer;
workstation computer;
laptop computer;
personal digital assistant;
cellular telephone;
telephone;
television and set-top box combination.

4. The system of claim 1, wherein said services have a type selected from the group consisting of:
printing;
fax storage;
video playback;
audio playback;
voicemail;
bill examination;
bill payment;
heating control;
air conditioning control;
ventilation control;
electrical power control.

5. A system for controlling electrical power at a remote location, comprising:
a signal-controlled power switch;
a network interface; and
a controller that provides a signal to said signal-controlled power switch based on data from the network interface.

6. The system of claim 5, wherein said system further includes a circuit breaker.

7. The system of claim 6, wherein said network interface uses a physical-layer link selected from the group consisting of:
twisted-pair wire;
coaxial cable;
electromagnetic radiation;
electrical wire;
telephone lines.

8. A system for dynamic update of user preferences, comprising:
a plurality of database entries containing user preferences;
a plurality of database entries containing user service request histories; and
a service request history analyzer for determining user preferences based on said service request history.

9. The system of claim 8, wherein said service request history analyzer automatically updates said user preferences.

10. The system of claim 8, wherein said service request history analyzer generates a notification to recommend the update of a user preference.
